(19) United States
(12) Patent Application Publication
(10) Pub. No.: US 2013/0075993 A1
(43) Pub. Date: Mar. 28, 2013

(54) TRUSS AND TROLLEY ASSEMBLY

(71) Applicants: Huntly CHRISTIE, Orlando, FL (US); Dan SOUWAND, Toronto (CA)

(72) Inventors: Huntly CHRISTIE, Orlando, FL (US); Dan SOUWAND, Toronto (CA)

(73) Assignee: CHRISTIE LITES ENTERPRISES CANADA INC., Toronto (CA)

(21) Appl. No.: 13/247,501

(22) Filed: Sep. 28, 2011

(51) Int. Cl. B62B 5/00

(52) U.S. Cl. 280/79.3

(57) ABSTRACT

A truss and trolley assembly is provided for the transport and assembly of truss components. The truss has a frame which has a pair of substantially parallel side walls which are horizontally spaced apart, the bottoms of the side walls have couplers. The frame also has an upper wall, perpendicular to the side walls, which is connected to top surfaces of each of the side walls. The frame also has a pair of tracks, each track being mounted to an inside surface of each of the side walls and a fixture mount slideably mounted on the pair of tracks. The trolley has a base having a top and a bottom. A plurality of rollers mounted on the bottom of the base. A plurality of vertical supports extend from the top of the base and each vertical support have means for detachably receiving a corresponding one of the couplers.

### TECHNICAL FIELD

The present disclosure generally relates to truss and trolley assemblies.

### TECHNICAL BACKGROUND

Truss and trolley assembly may be used in a variety of industries, including the entertainment industry, where they are used for the construction of truss assemblies with lighting, cameras, and speaker systems mounted thereon. In some applications, truss assemblies may be constructed by joining a plurality of truss sections together.

Truss assemblies are typically constructed by placing each section of truss adjacent to one another and joining them together. This takes a considerable amount of time and effort due to the unwieldy weight of the components. After the truss assembly is complete, the assembly must be partially lifted so that various components (such as lighting, camera, or sound components) may be mounted at various positions along the lower potion of the truss assembly. The equipment being mounted is typically also heavy and unwieldy, making the process difficult and time-consuming.

Sections of truss may be transported by storing the sections in boxes or cases. Components (such as lighting, camera, or sound equipment) may also be transported by storing them in boxes or cases. It is typically extremely costly to transport the truss sections and components due to the weight of the equipment, and the volume of space required.

### BRIEF DESCRIPTION OF THE DRAWINGS

In drawings which illustrate by way of example only a preferred embodiment,

FIG. 1 is a perspective view of an embodiment of a truss and trolley.

FIG. 2 is a perspective view of the trolley.

FIG. 3 is a perspective view of a further embodiment of the trolley comprising a pair of top rails.

FIG. 4 is a perspective view of a further embodiment of the trolley comprising a pair of hitching members.

FIG. 5 is a perspective view of a pair of the trolleys shown in FIG. 4 hitched together.

FIG. 6 is a perspective view of the embodiment of the trolley shown in FIG. 1 and a further embodiment of a truss.

FIG. 7 is a perspective view of a pair of trusses and trolleys of FIG. 6 in a stacked orientation.

### DETAILED DESCRIPTION

There is therefore provided a truss and trolley assembly for transporting truss sections and components mounted thereon (for example, lighting, camera, or sound components). There is also provided a means for adjusting the position of the mounted components without having to hoist the truss section from the trolley.

In one aspect, the truss comprises: a frame having a pair of side walls substantially parallel to one another and horizontally spaced apart, the bottoms of each of the pair of side walls comprise a plurality couplers, an upper wall, perpendicular to the pair of side walls, wherein the upper wall is connected to top surfaces of each of the pair of side walls; a pair of tracks, each track being mounted to an inside surface of each of the pair of side walls; and a fixture mount slideably mounted on the pair of tracks. The trolley comprises: a base having a top and a bottom and a plurality of rollers mounted on the bottom of the base; and a plurality of vertical supports extending from the top of the base, wherein each of the vertical supports comprise means for detachably receiving a corresponding one of the couplers.

In another aspect, the trolley further comprises a plurality of horizontal supports mounted in between adjacent vertical supports, the horizontal supports being vertically spaced from the base of the trolley.

In yet another aspect, the trolley further comprises at least one hitching member hingeably mounted on one of the vertical supports for hitching to an adjacent truss and trolley assembly.

In a further aspect, the upper wall comprises a pair of slotted cross pieces horizontally spaced apart, perpendicular to the pair of side walls, and positioned substantially near the ends of the upper wall, whereby the slots of the pair of cross pieces are adapted to receive a plurality of rollers, whereby when a first truss and trolley assembly is stacked on a second truss and trolley assembly, the pair of slotted cross pieces of the second truss and trolley assembly receives the rollers of the first truss and trolley assembly, preventing the rollers from any rolling movement.

In still a further aspect, the upper wall comprises a pair of slotted cross pieces horizontally spaced apart, perpendicular to the pair of side walls, and positioned substantially near the ends of the upper wall, the pair of slotted cross pieces each comprising a pair of troughs for receiving a roller, whereby when a first truss and trolley assembly is stacked on a second truss and trolley assembly, the troughs of the second truss and trolley assembly receives the rollers of the first truss and trolley assembly, preventing the rollers from any rolling movement.

In another aspect, a plurality of trusses may be joined together to form a truss assembly, and the respective pair of tracks of each of the plurality of trusses form a continuous track, whereby the fixture mounts of each of the plurality of trusses may be positioned at any point along the said continuous track.

In still another aspect, the truss comprises: a frame having a pair of side walls, the pair of side walls being substantially parallel to one another and horizontally spaced apart, wherein the bottoms of each of the pair of side walls comprises a plurality of couplers and an upper wall, perpendicular to the pair of side walls, wherein the upper wall is connected to the tops of each of the pair of side walls; a pair of tracks, wherein each track is mounted on the inside of each of the pair of side walls; and a fixture mount, slideably mounted on the pair of tracks. The trolley comprises: a base having a top and a bottom and a plurality of rollers mounted on the bottom of the base; a plurality of vertical supports mounted to the top of the base; and a pair of horizontal supports parallel to one another and spaced apart, each mounted to the tops of two of the plurality of vertical supports, wherein the tops of the horizontal supports comprise couplers for detachably receiving the plurality of couplers of the pair of side walls of the truss.

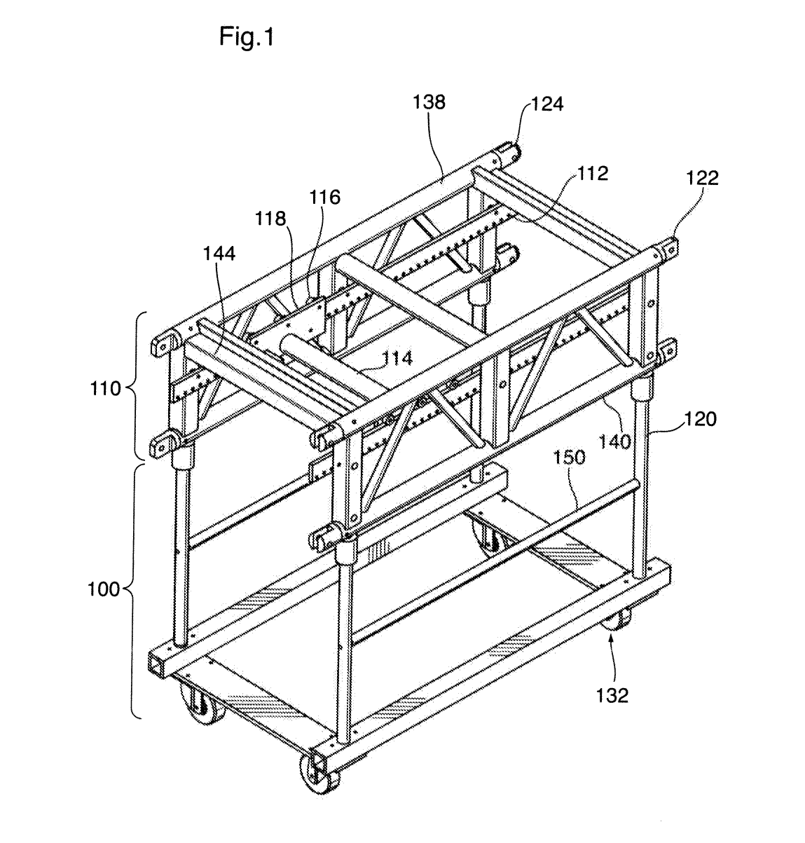

FIG. 1 is a perspective view of an embodiment of a truss and trolley assembly. In this figure, a truss section 110 is shown mounted on trolley 100. Trolley 100 comprises a base assembly 130, a plurality of vertical supports 120, and a plurality of rollers 132. The plurality of vertical supports 120 are attached on the bottom end to the top side of the base assembly 130. Trolley 100 may further comprise a pair of cross-members 150 mounted on opposite sides of trolley 100. Cross-members 150 are attached to adjacent vertical supports 120 to provide a means for lifting the trolley 100 and for providing lateral support to vertical supports 120. The plurality of rollers 132 are attached to the underside of the base assembly 130. The rollers 132 are preferably swivebly mounted, such that rollers 132 may swivel about a vertical axis.

Truss section 110 comprises a frame and a pair of tracks 112. The frame comprises a pair of side walls 126, each side wall comprising an upper horizontal bar 138, a lower horizontal bar 140, a plurality of vertical bars 128, and a plurality of lattice bars 142. The plurality of lattice bars 142 extend from the upper horizontal bars 138 to the lower horizontal bar 142 and form an oblique angle with said horizontal bars. The frame further comprises one or more cross members 144 which connect the pair of side walls 126.

Each trolley 100 and truss section 110 assembly may be adapted to stack on top of another trolley 100 and truss section 110 assembly. In the example shown in FIG. 1, truss section 110 the cross members 144 positioned at or near the ends of truss section 110 may be flanged. When a first trolley 100 and truss section 110 assembly is stacked on top of a second trolley 100 and truss section 110 assembly, the rollers 132 of the trolley 100 and first truss section 110 assembly slot into the flanged portion of the flanged cross member 144 of the second trolley 100 and truss 110 assembly. In this way, the rollers 132 of the first trolley 100 and truss 110 assembly are prevented from rotating, thereby preventing the first trolley 100 and truss 110 assembly from shifting when it is stacked onto the second trolley 100 and truss 110 assembly.

A track 112 is mounted on the inner face of each of the pair of side walls 126. Fixture mount 114 is slideably mounted on the pair of tracks 112. In the example shown in FIG. 1, fixture mount 114 may comprise a pair of side brackets 118. Each side bracket comprises a plurality of rollers 116 so that fixture mount 114 may be slid along the pair of tracks 112 when the fixture mount 114 is not fixed in place. Fixture mount 114 may be fixed in place at different points along the pair of tracks 112. In the example shown in FIG. 1, fixture mount 114 may be fixed by providing the pair of tracks 112 with a plurality of apertures spaced apart along their length. Side brackets 118 may also comprise a plurality of apertures which are spaced so that they may be aligned with the apertures on the pair of tracks 112. Bolts, screws, or the like may then be inserted through both an aperture of a track 112 and of a side bracket 118, fixing the fixture mount 114 in place. In operation, multiple bolts, screws, or the like may be used to fix the fixture mount 114 in place.

Truss section 110 may further comprise a plurality of connectors 122, 124 for joining two or more truss sections together. In the example shown in FIG. 1, truss section 110 comprises a plurality of male connectors 122 and a plurality of female connectors 124. The connectors 122, 124 are arranged such that when two truss sections are positioned adjacent to one another, the male connectors 122 of the first truss section are positioned to mate with female connectors 124 of the second truss section. The plurality of connectors 122 and 124 may be provided on side walls 126 of truss section 110. In order for adjacent truss sections 110 to be joined, connectors 122, 124 on a first end of the side wall 126 will have the opposite orientation as the connectors 122, 124 on a second end of the side wall 126, such that when a first and second truss section 110 are adjacent to one another, the plurality of female connectors 124 of the first truss section 110 are aligned with the plurality of male connectors 122 of the second truss section 110, and vice versa. The connectors 122, 124 also comprise some means for fixing the trusses in place once the connectors 122, 124 have been mated together. For example, male connectors 122 and female connectors 124 may each comprise apertures which, when the connectors 122, 124 are mated, the apertures of each of the connectors 122, 124 are aligned such that a bolt, a screw, or the like can be inserted therein to fixably join the truss sections 110. When a plurality of truss sections 110 are joined together, the pair of tracks 112 for each truss section join with the pair of tracks 112 of adjacent truss sections 110 to form a pair of continuous tracks that run along the length of the plurality of joined truss sections 110. Fixture mounts 114 may be positioned anywhere along the length of the pair of continuous tracks.

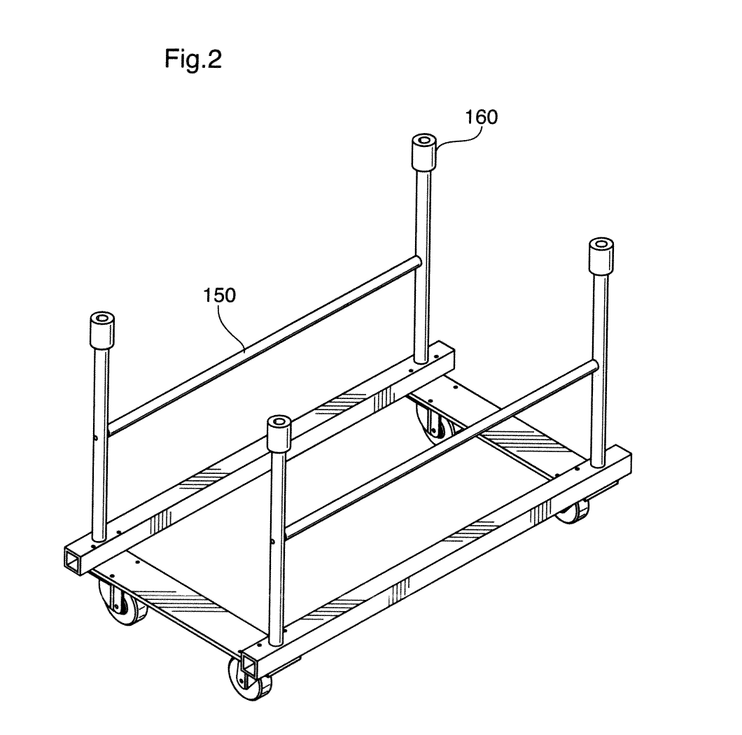

Truss section 110 may be detachably mounted on the trolley 100. In the example shown in FIG. 1, truss section 110 is supported by the plurality of vertical supports 120. The plurality of vertical supports 120 and truss section 110 are adapted such that truss section 110 may be attached to and/or detached from trolley 100. For example, vertical supports 120 and truss section 110 may each comprise couplers for detachably coupling the truss section 110 and trolley 100. In the embodiment depicted in FIG. 2, each of the vertical supports 120 may comprise a female coupler 160, which is adapted to receive a male coupler (not shown). Truss section 110 may comprise a plurality of male couplers adapted to mate with the plurality of female couplers 160 of trolley 100. Those skilled in the art will appreciate that other means may be used to secure the truss section 110 to the trolley 100.

Those skilled in the art will appreciate that a variety of components may be mounted on the fixture mount 114, including, for example cameras, light fixtures, and speakers, among other things. An example of this is illustrated in FIGS. 10 and 11.

A plurality of truss sections 110 may be joined to form truss assemblies. Each of the trolley 100 and truss section 110 assemblies may be positioned adjacent to other trolley 100 and truss section 110 assemblies such that the plurality of connectors 122, 124 on the trolley 100 and truss section 110 assembly are positioned to mate with a complimentary set of connectors 122, 124 on adjacent trolley 100 and truss section 110 assemblies. The examples in the figures illustrate truss sections 110 which form a generally straight section of a truss assembly. However, in order to construct truss assemblies of various shapes and sizes, truss sections 110 may be in different shapes or orientations than what is shown in the figures. For example, the pair of side walls and the pair of tracks 112 of truss section 110 may be curved, such that the plurality of connectors 122, 124 at a first end of truss section 110 may be at an angle with respect to the plurality of connectors 122, 124 at a second end.

Once a truss assembly has been constructed by joining a plurality of truss sections 110, fixture mounts 114 (and the components mounted thereon) may be positioned anywhere along the perimeter of the truss assembly by sliding the fixture mounts 114 along the continuous track created by the plurality of tracks 112. Once fixture mounts 114 have been positioned, the truss assembly may be lifted from the plurality of trolleys 100.

FIG. 2 illustrates the trolley 100 as shown in FIG. 1 apart from truss section 110.

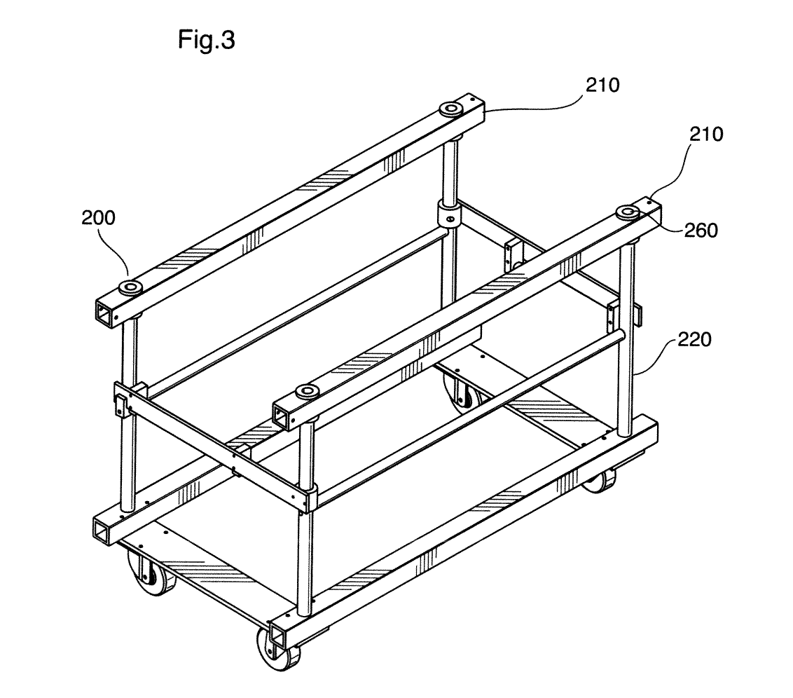

FIG. 3 illustrates a further embodiment of a trolley 200. In this embodiment, a pair of horizontal supports 210 is provided on opposite sides of trolley 200. Similar to cross-members 150 of the embodiment shown in FIG. 1, the horizontal supports 210 are mounted to adjacent vertical supports 220 to provide a means for lifting the trolley 200 and for providing lateral support to vertical supports 220. Each horizontal support 210 may comprise, at or near each end of the support 210, a plurality of female couplers 260 for receiving a plurality of complementary male couplers provided on truss section 110 (not shown).

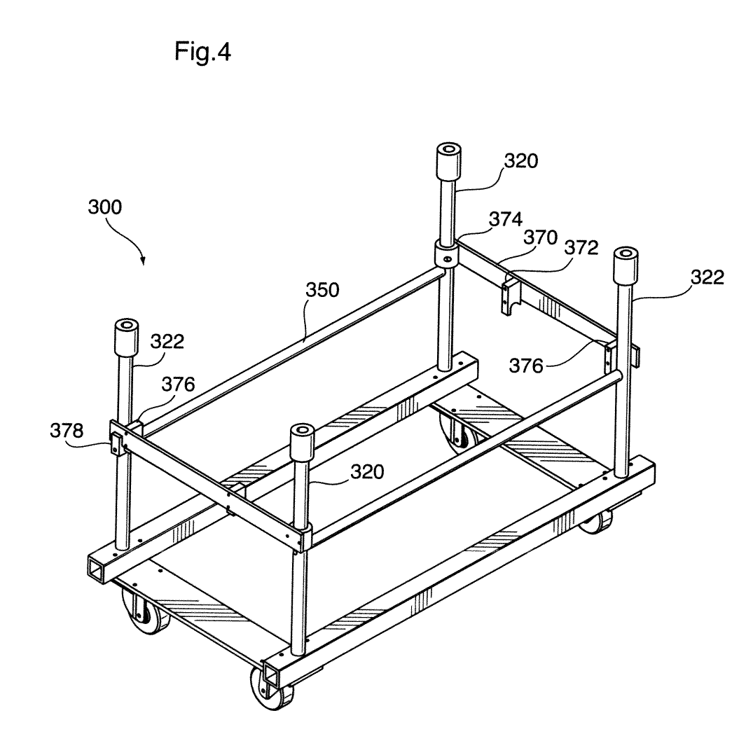

FIG. 4 illustrates a further embodiment of trolley 300. A pair of hitching members 370 are provided, each of which is hingeably mounted on opposite corners of trolley 300. A first end of each of said hitching members 370 is hingeably and slideably mounted to a first vertical support 320, such that the hitching members 370 may be rotated about the axis defined by the first vertical support 320, and may move vertically along the first vertical support 320. A holder 378 is provided on a second vertical support 322 adjacent to the first vertical support 320 for holding a second end of the hitching member 370 in place. When each of the pair of hitching members 370 are held in place by their respective holders 378, hitching members are positioned on opposite ends of trolley 300. Trolley 300 further comprises a pair of cross-members 350 positioned on opposite sides of the trolley, and mounted on a pair of adjacent vertical supports 320.

Hitching member 370 comprises some means for hitching the trolley to a second trolley. In the example shown in FIG. 4, hitching member 370 comprises two brackets 372, and 376. Each of the two brackets comprises a groove for receiving a cross-member 350. The middle bracket 372 may be positioned such that when hitching member 370 is hitched to cross-member 350 of an adjacent trolley 300, the middle bracket 372 preferably abuts a vertical support 320. Thus, when a pair of trolleys 300 are hitched together, the distance between them is fixed. The end bracket 376 is positioned proximate to the distal end of hitching member 370.

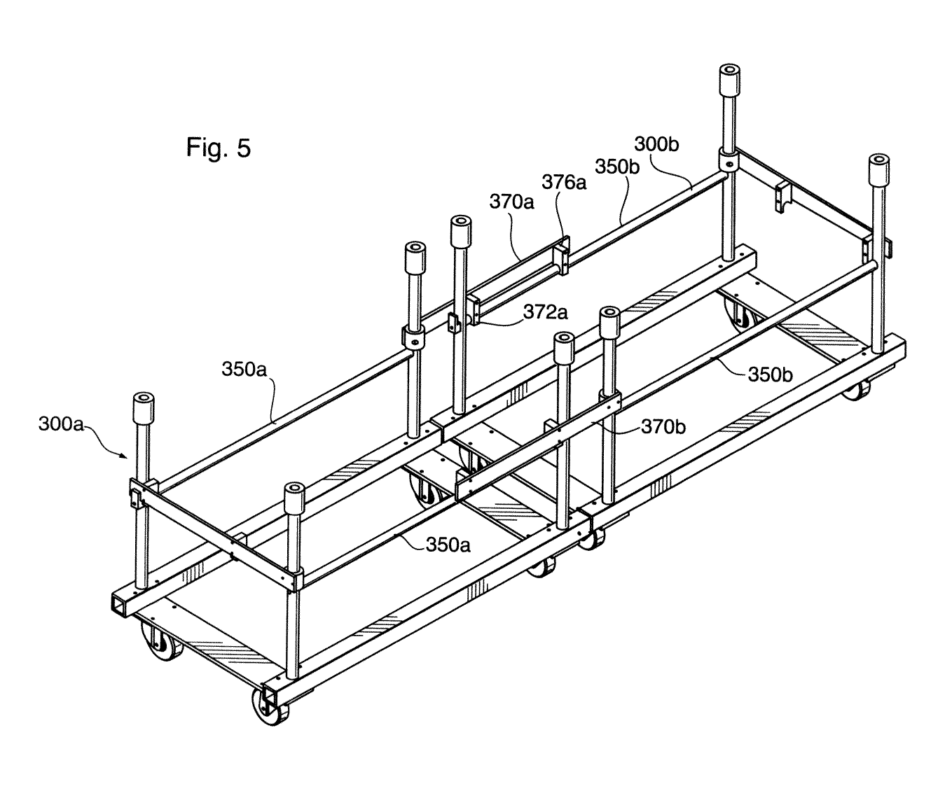

FIG. 5 illustrates how a first trolley 300a and a second trolley 300b may be hitched together. First trolley 300a and second trolley 300b are positioned end to end. Hitching member 370a of a first trolley 300a may be lifted from holder 378a and may be rotated and positioned such that it is parallel with cross-member 350b of the second trolley 300b. The middle bracket 372a and end bracket 376a of the hitching member 370a may then be fitted onto the cross-member 350b of the second trolley 300b, preventing the hitching member 370a from rotating. Similarly, the hitching member 370b of a second trolley 300b may be hitched with the cross-member 350a of the first trolley 300a. This embodiment is particularly advantageous, as a series of trolleys may be hitched together, allowing them to be moved as a group as opposed to individually.

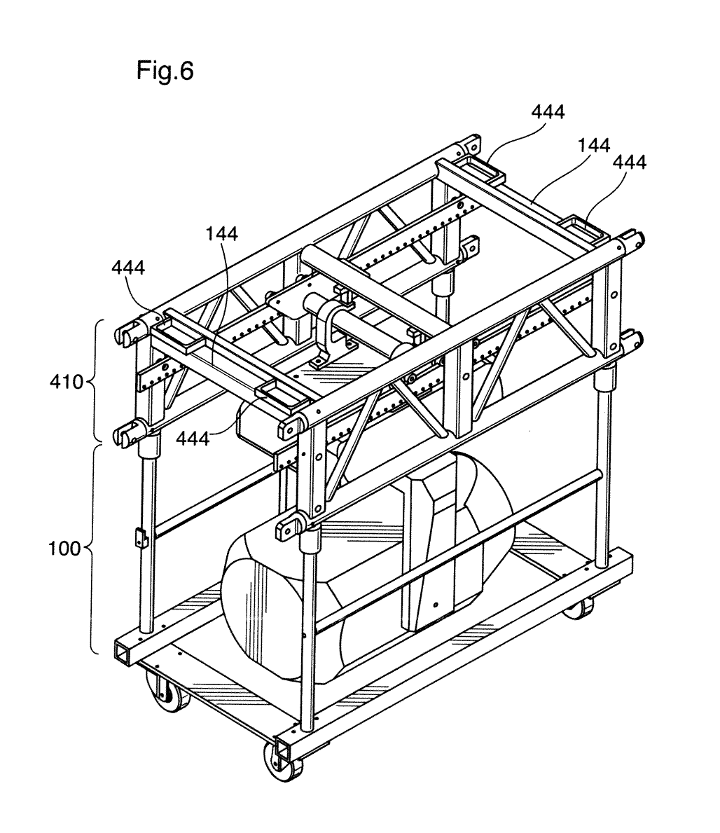

FIG. 6 illustrates a further embodiment of truss section 410 mounted on a trolley 300. Truss section 410 further comprises a plurality of troughs 444. In this embodiment, troughs 444 are shown mounted on flanged cross members 144. Troughs 444 are for receiving rollers 132 when one trolley is stacked on another trolley.

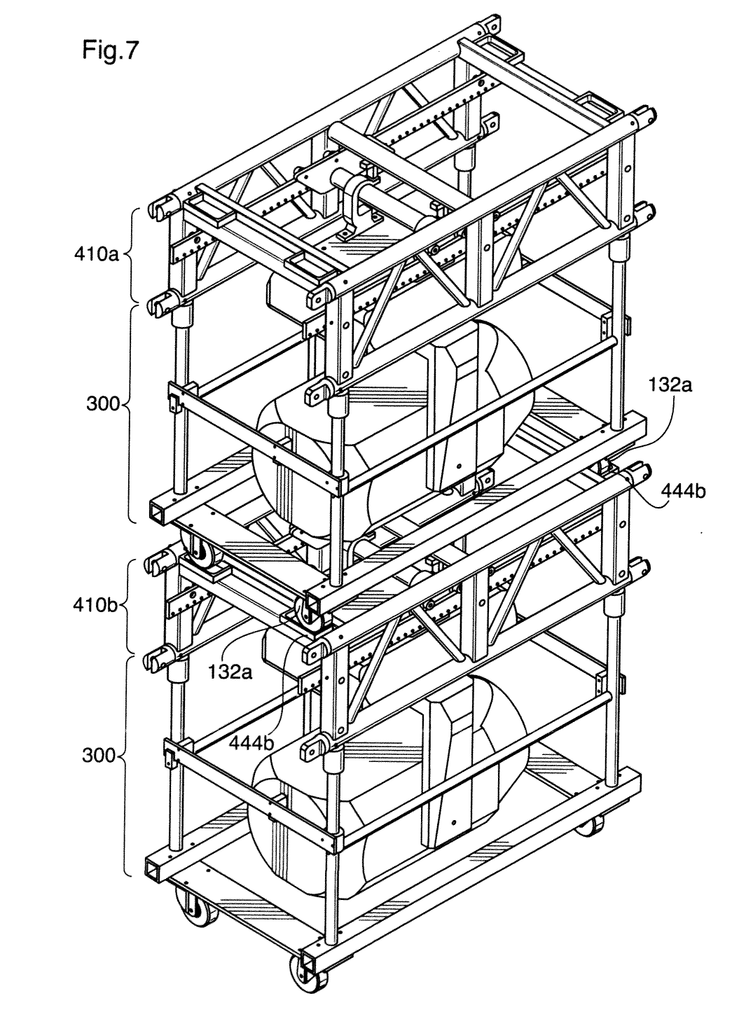

FIG. 7 illustrates how a trolley 300a and truss section 410a may be stacked on another trolley 300b and truss section 410b. In this Figure, rollers 132 of the top trolley 300a are received by the troughs 444b of the bottom truss 410b. The troughs 444b are adapted to restrict the movement of top trolley 300a and truss section 410a assembly so that it does not roll off the bottom trolley 300b and truss section 410b assembly. This embodiment is advantageous as it allows truss and trolley assemblies to be stored more efficiently.

FIG. 6 also illustrates a lighting component which is shown mounted on the fixture mount 114. The lighting component generally resides within the footprint created by the base assembly 130, and is generally surrounded by said assembly 130 below, the vertical supports 120 around the sides, and the truss section 110 above. By providing a frame on the trolley 100 which surrounds the lighting component, the lighting component is protected from being damaged while in transport without having to provide a separate enclosure for the lighting component. In one example, the trolley 100 and truss section 110 assembly may be used solely as a means for transporting the lighting component. In another example, a plurality of trolleys 100 may be wheeled together, allowing the mounted truss sections 110 to join together to create a truss assembly. Once joined, the positioning of the various lighting component may be adjusted along the length of the pair of continuous tracks.

Various embodiments having been thus described in detail by way of example, it will be apparent to those skilled in the art that variations and modifications may be made and still achieve the desired outcome. The embodiments described herein include all such variations and modifications as fall within the scope of the appended claims.

1. A truss and trolley assembly, comprising:
a truss comprising:
a frame comprising:
a pair of side walls substantially parallel to one another and horizontally spaced apart, the bottoms of each of the pair of side walls comprise a plurality couplers;
an upper wall, perpendicular to the pair of side walls, wherein the upper wall is connected to top surfaces of each of the pair of side walls;
a pair of tracks, each track being mounted to an inside surface of each of the pair of side walls; and
a fixture mount slideably mounted on the pair of tracks; and
a trolley comprising:
a base having a top and a bottom and a plurality of rollers mounted on the bottom of the base; and
a plurality of vertical supports extending from the top of the base, wherein each of the vertical supports comprise means for detachably receiving a corresponding one of the couplers.

2. The truss and trolley assembly of claim 1, the trolley further comprising a plurality of horizontal supports mounted in between adjacent vertical supports, the horizontal supports being vertically spaced from the base of the trolley.

3. The truss and trolley assembly of claim 2, wherein the trolley further comprising at least one hitching member hingeably mounted on one of the vertical supports for hitching to an adjacent truss and trolley assembly.

4. The truss and trolley assembly of claim 1, wherein the upper wall comprises a pair of slotted cross pieces horizontally spaced apart, perpendicular to the pair of side walls, and positioned substantially near the ends of the upper wall, whereby the slots of the pair of cross pieces are adapted to receive a plurality of rollers, whereby when a first truss and trolley assembly is stacked on a second truss and trolley assembly, the pair of slotted cross pieces of the second truss and trolley assembly receives the rollers of the first truss and trolley assembly, preventing the rollers from any rolling movement.

5. The truss and trolley assembly of claim 1, wherein the upper wall comprises a pair of slotted cross pieces horizontally spaced apart, perpendicular to the pair of side walls, and positioned substantially near the ends of the upper wall, the pair of slotted cross pieces each comprising a pair of troughs for receiving a roller, whereby when a first truss and trolley assembly is stacked on a second truss and trolley assembly, the troughs of the second truss and trolley assembly receives the rollers of the first truss and trolley assembly, preventing the rollers from any rolling movement.

6. The truss and trolley assembly of claim 1, whereby a plurality of trusses may be joined together to form a truss assembly, and the respective pair of tracks of each of the plurality of trusses form a continuous track, whereby the fixture mounts of each of the plurality of trusses may be positioned at any point along the said continuous track.

7. A truss and trolley assembly, further comprising:
a truss, comprising:
a frame, comprising:
a pair of side walls, the pair of side walls being substantially parallel to one another and horizontally spaced apart, wherein the bottoms of each of the pair of side walls comprises a plurality of couplers; and
an upper wall, perpendicular to the pair of side walls, wherein the upper wall is connected to the tops of each of the pair of side walls;
a pair of tracks, wherein each track is mounted on the inside of each of the pair of side walls; and
a fixture mount, slideably mounted on the pair of tracks; and
a trolley, comprising:
a base having a top and a bottom and a plurality of rollers mounted on the bottom of the base;
a plurality of vertical supports mounted to the top of the base; and
a pair of horizontal supports parallel to one another and spaced apart, each mounted to the tops of two of the plurality of vertical supports, wherein the tops of the horizontal supports comprise couplers for detachably receiving the plurality of couplers of the pair of side walls of the truss.
